(19) United States
(12) Patent Application Publication
(10) Pub. No.: US 2012/0270597 A1
(43) Pub. Date: Oct. 25, 2012

(54) MOBILE PHONE WITH MOUSE AND KEYBOARD FUNCTION

(75) Inventor: Guang-Feng Ou, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/282,644

(22) Filed: Oct. 27, 2011

(30) Foreign Application Priority Data
Apr. 25, 2011 (CN) 201110103360.0

(51) Int. Cl. H04W 88/02

(52) U.S. Cl. 455/556.1

(57) ABSTRACT

A mobile phone with mouse and keyboard functions includes a communication unit, a mouse unit, a keyboard unit, and a mode switch. The mode switch is capable of selectively activating the mobile phone to act as a mobile phone, or whereby the mobile phone acts as a mouse, or whereby the mobile phone acts as a keyboard.

### BACKGROUND

1. Technical Field

The present disclosure generally relates to mobile phones, and particularly to a mobile phone capable of performing as a keyboard and as a mouse.

2. Description of Related Art

Portable tablet personal computers (PC) have become much more popular in recent years. Some people find it difficult to input text or operations with the touch-screen of the tablet PC. However, it is inconvenient to carry around a traditional mouse and keyboard to be used with the tablet PC.

Therefore, there is room for improvement in the art.

### BRIEF DESCRIPTION OF THE DRAWINGS

Many aspects of the disclosure can be better understood with reference to the following drawings. The components in the drawing are not necessarily drawn to scale, the emphasis instead being placed upon clearly illustrating the principles of the disclosure.

FIG. 1 is a side view of a mobile phone in accordance with an exemplary embodiment of the present disclosure.

FIG. 2 is a top view of the mobile phone of FIG. 1.

FIG. 3 is a block diagram of the circuit of the mobile phone of FIG. 1.

FIG. 4 is a top view of the mobile phone of FIG. 1 further equipped with a shielding cover.

### DETAILED DESCRIPTION

Reference will be made to the drawings to describe the present mobile phone, the subject of this disclosure, in detail.

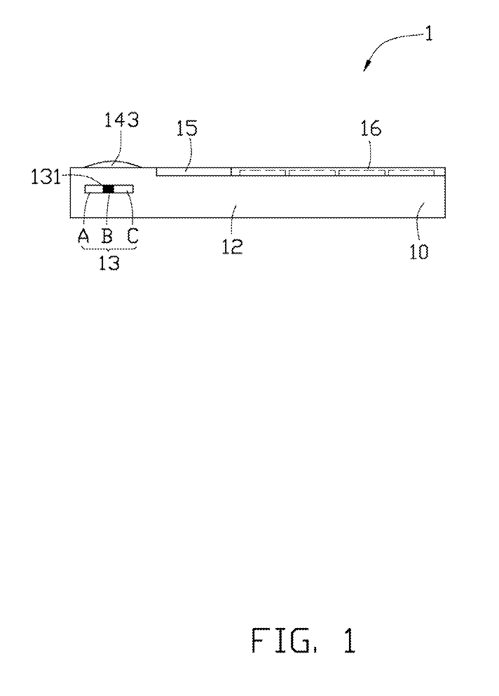

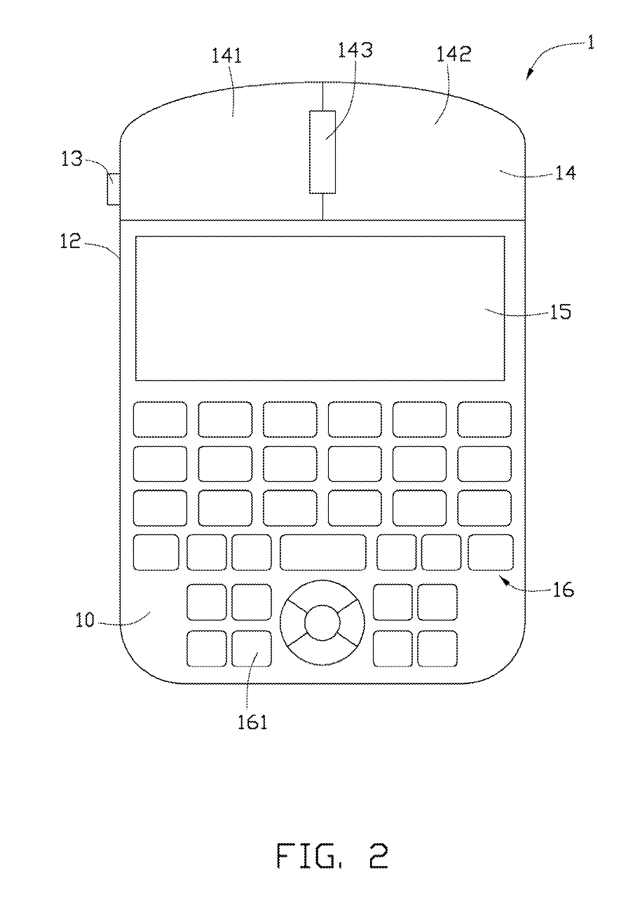

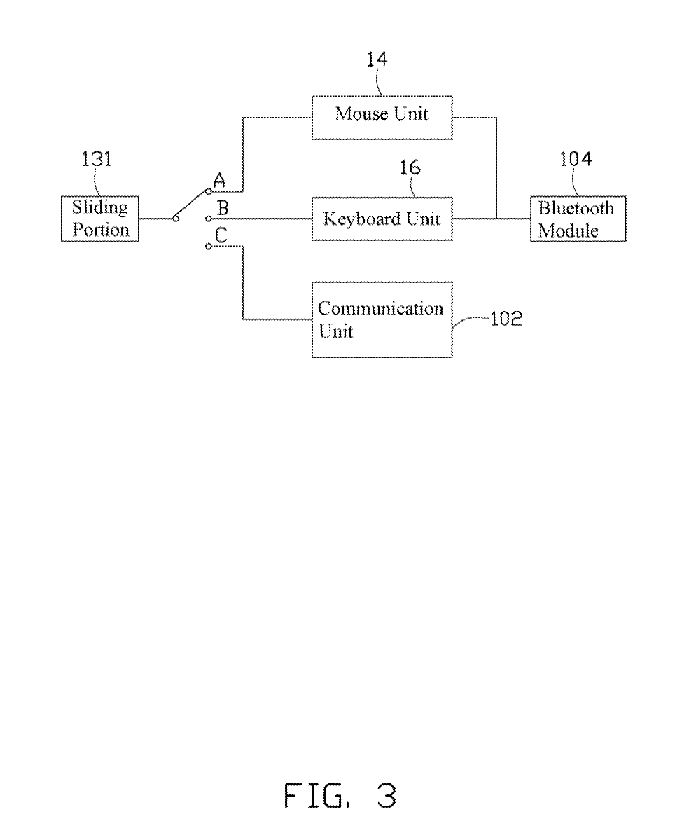

Referring to FIG. 1 and FIG. 2, a mobile phone 1 according to an exemplary embodiment includes a main body 10, a mouse unit 14 and a keyboard unit 16. The main body 10 has a communication unit 102 and a bluetooth module 104 (FIG. 3) arranged therein. The bluetooth module 104 is capable of communicating with the mouse unit 14, the keyboard unit 16 and an external computer (not labeled).

The main body 10 is generally cuboid. The main body 10 has a liquid crystal display (LCD) panel 15 arranged at a middle portion. The main body 10 further includes two lateral walls 12. One of the two lateral walls 12 has a mode switch 13 arranged thereon.

The mouse unit 14 is arranged at the top of the main body 10. The mouse unit 14 includes a left mouse button 141, a right mouse button 142 and a mouse wheel 143 between the left mouse button 141 and the right mouse button 142. The mouse unit 14 further includes an optical sensor, an optical lens, a light emitting diode (LED) and a processor (not labeled) for performing a mouse function. The optical sensor can be a complementary metal-oxide semiconductor (CMOS) sensor. The LED can be a red LED on a bottom of the phone 1. The processor can be a digital signal processor (DSP).

When an object, or the surface of an object, is presented to the mobile phone 1, light emitted from the LED hits the surface and bounces off that surface onto the optical sensor to form images. The optical sensor sends each image to the processor for analysis. The processor is able to detect patterns in the images and see how those patterns have moved since a previous image. Based on the change in patterns over a sequence of images, the processor is capable of determining the distance and direction the mouse unit 14 has moved and sending the corresponding coordinates to the external computer by the bluetooth module 104.

The keyboard unit 16 is arranged at the bottom of the main body 10. The keyboard unit 16 includes a processor, a circuit board with circuitry that carries information to and from the processor, a plurality of keys 161, and a decoder. The keyboard unit 16 includes a processor and circuitry that carries information to and from the processor. A large part of this circuitry makes up a key matrix, which is a grid of conductive lines underneath the keys 161. Each circuit is broken at a point below each key cap. When a key cap is pressed, it completes a circuit and allows a tiny amount of current to flow through. When the processor finds a circuit which has been completed in this way, it compares the location of that circuit on the key matrix to the character map in its read-only memory (ROM). The character map is basically a comparison chart or lookup table, which has a list of each key in the matrix and what each key, or combination of keystrokes, represents. When communicating with the external computer through the bluetooth module 104, the key board unit 16 is capable of performing as an input device to the external computer.

The mode switch 13 includes a sliding portion 131. The sliding portion 131 is capable of sliding along the lateral wall 12 where the mode switch 13 sits. Also referring to FIG. 3, inside of the main body 10, a first contact “A”, a second contact “B” and a third contact “C” are arranged. The contact “A” is connected to an operating circuit of the mouse unit 14. The contact “B” is connected to an operating circuit of the keyboard unit 16. The contact “C” is connected to the communication unit 102. The sliding portion 131 respectively contacts one of the three contacts at three different positions on the sliding path on the lateral wall 12.

Accordingly, the sliding portion 131 works as a switch for allowing or breaking a power supply to the operating circuit of the mouse unit 14, the operating circuit of the keyboard unit 16, and the communication unit 102.

When the sliding portion 131 contacts the first contact “A”, the mobile phone 1 is switched to a mouse mode, in which the mouse unit 14 is activated to work. In this condition, the mobile phone 1 can be used as a mouse.

When the sliding portion 131 contacts the second contact “B”, the mobile phone 1 is switched to a keyboard mode, in which the keyboard unit 16 is activated to work. In this condition, the mobile phone 1 can be used as a keyboard.

When the sliding portion 131 contacts the third contact “C”, the mobile phone 1 is switched to a communication mode, in which the communication unit 102 is activated to work. In this condition, the mobile phone 1 can be used as a normal telephone.

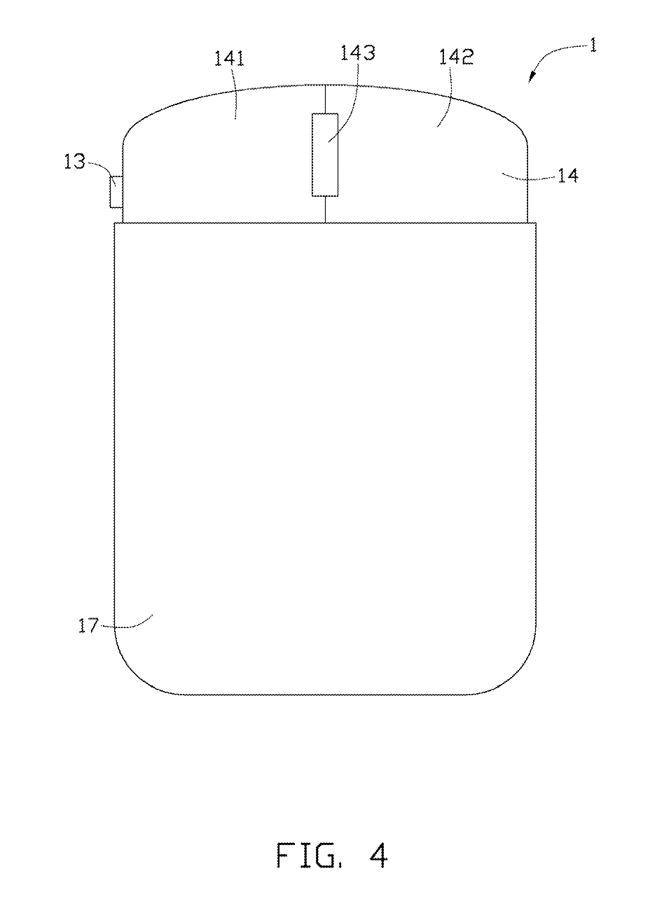

Referring to FIG. 4, the mobile phone 1 can further include a shielding cover 17. In mouse mode, the shielding cover can be moved to cover the LCD panel 15 and the keyboard 16, thereby protecting the LCD panel 15 and the keyboard 16 from damage. In the keyboard mode and the communication mode, the shielding cover can be removed to expose the LCD panel 15 and the keyboard 16 for use.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A mobile phone with mouse and keyboard function comprising:
a communication unit;
a mouse unit;
a keyboard unit; and
a mode switch for selectively activating one of the communication unit, the mouse unit, and the keyboard unit to work.

2. The mobile phone of claim 1, wherein the mobile phone comprises a main body with a front portion and an end portion, the mouse unit being arranged at the front portion, the key board unit being arranged at the end portion.

3. The mobile phone of claim 2, wherein the mouse unit comprises a left mouse button, a right mouse button, and a mouse wheel between the left mouse button and the right mouse button.

4. The mobile phone of claim 2, wherein the mode switch arranged on a lateral wall of the main body of the mobile phone.

5. The mobile phone of claim 4, wherein the mode switch comprises a sliding portion capable of sliding along a surface of the lateral wall where the mode switching button sits.

6. The mobile phone of claim 4, wherein the mode switch comprises a sliding portion, a first contact, a second contact and a third contact, the sliding portion being capable of sliding along the lateral wall and selectively contacting one of the three contacts, the mouse unit capable of being activated to work when the sliding portion contacts the first contact, the keyboard capable of being activated to work when the sliding portion contacts the second contact, the communication unit capable of being activated to work when the sliding portion contacts the third contact.

7. The mobile phone of claim 2, further comprising a display panel, wherein the mobile phone comprises a middle portion between the front portion and the end portion, the display panel being arranged at the middle portion.

8. The mobile phone of claim 7, further comprising a shielding cover for covering the display panel and the keyboard unit when the mouse unit is activated to work, and exposing the display panel and the keyboard unit when the communication unit or the keyboard unit is activated.
